(19) United States
(12) Patent Application Publication
(10) Pub. No.: US 2017/0106904 A1
(43) Pub. Date: Apr. 20, 2017

(54) Control Method For Vehicle With Electronic Steering Column Lock

(71) Applicant: Ford Global Technologies, LLC, Dearborn, MI (US)

(72) Inventors: Ryan Edwin Hanson, Livonia, MI (US); Paul Candiago, Windsor (CA); Ronald Patrick Brombach, Plymouth, MI (US)

(21) Appl. No.: 14/885,189

(22) Filed: Oct. 16, 2015

(51) Int. Cl. B62D 6/10; B62D 5/04

(52) U.S. Cl. CPC B62D 6/10; B62D 5/04

(57) ABSTRACT

Side loads on an Electronic Steering Column Lock (ESCL) can prevent the ESCL from releasing upon command. An Electric Power-Assisted Steering (EPAS) system is used to reduce or eliminate any side load on the ESCL to mitigate this problem. The EPAS system is activated in response to driver authentication before the driver requests a transition to a ready-to-drive state. The ready-to-drive state is entered only if the ESCL is unlocked. If a predetermined time elapses between driver authentication and the request to enter ready-to-drive state, the EPAS is deactivated and the ESCL is commanded to re-lock.

### TECHNICAL FIELD

This disclosure relates to the field of vehicle controls. More particularly, the disclosure relates to a method of controlling an Electric Power-Assisted Steering (EPAS) system and an Electronic Steering Column Lock (ESCL).

### BACKGROUND

A vehicle steering system is illustrated in FIG. 1. Mechanical connections are indicated by solid lines while dotted lines represent the flow of information. Left front wheel 10 is fixed to rotate with left axle shaft 12 while right front wheel 14 is fixed to rotate with right axle shaft 16. In a front wheel drive or four wheel drive vehicle, the left and right axle shafts would be powered via a differential (not shown). In a rear wheel drive vehicle, the front wheels would not be powered. A driver controls the orientation of the axes about which the front wheels rotate by turning steering wheel 18 which if fixed to steering column 20. Pinion 22, fixed to steering column 20, meshes with gear teeth on rack 24. Rotation of steering column 20 causes translation of rack 24, which causes a change in the axis of rotation of wheels 10 and 14.

The amount of torque required to steer the vehicle varies depending upon vehicle speed. The torque required can be excessive for many drivers, especially at low vehicle speed. Consequently, some vehicles are equipped with electric power assisted steering (EPAS) systems. Assist motor 26 applies torque to steering column 20 in response to commands from controller 28. When EPAS is active, controller 28 continuously monitors the torque applied to steering column 20, as indicated by torque sensor 30, and commands assist motor 26 to apply a torque in the same direction with a magnitude proportional to the steering column torque. The constant of proportionality may be adjusted based on other sensors, such as vehicle speed sensor 32 or steering angle sensor 34 to adjust the degree of assistance. Typically, more assistance is provided at low speed while less assistance is provided at high speed to preserve tactile feedback to the driver at high speed.

To deter theft, some vehicles include an Electronic Steering Column Lock (ESCL) 36 to limit rotation of the steering wheel except when an authorized driver is present. The presence of an authorized driver is traditionally indicated by insertion of an ignition key. FIG. 2 shows an ESCL in the locked position. Collar 40, which is fixed to steering column 20, has a number of teeth 42. Carriage 44 translates relative to a fixed guide 46 in response to a signal from controller 28. For example, controller 28 may energize a solenoid to generate a magnetic force on carriage 44 or may command a motor to translate carriage 44. Spring 48 pushes pin 50 with respect to carriage 44. This indirect action makes the mechanism tolerant of various alignments of teeth 42 with respect to pin 50. If pin 50 is aligned with one of the teeth, translation of carriage 44 compresses spring 50. When the steering column is turned slightly, the pin drops in to constrain rotation of the steering column. To disengage ESCL 36, controller 28 commands translation of carriage 44 in the opposite direction pulling pin 50 beyond the teeth 42 as shown in FIG. 3. In this position, steering column 20 can rotate freely.

### SUMMARY OF THE DISCLOSURE

A vehicle includes a steering column, an Electronic Steering Column Lock (ESCL), an Electronic Power-Assisted Steering system (EPAS), and a controller. The ESCL is engageable to limit rotation of the steering column. The EPAS system includes a sensor configured to detect a torque on the steering column and a motor configured to relieve the torque. The controller is programmed to respond to authentication of an operator by activating the EPAS to relieve a load on the ESCL and then by commanding disengagement of the ESCL. Authentication of the operator may be based on, for example, insertion of a key in an ignition switch, a button press of a wireless key fob, or operation of a driver door. The controller may be further programmed to respond to a request to enter a ready-to-drive state by testing a state of the ESCL and permitting generation of tractive force only if the ESCL is disengaged. The request to enter the ready-to-drive state may be based on rotation of a key in an ignition switch. The controller may also be further programmed to suspend operation of the EPAS and command the ESCL to re-lock if no request to enter the ready-to-drive state is received within a predetermined time after the authentication of the operator.

A method of controlling a vehicle includes responding to authentication of an operator and responding to a request from the operator to enter a ready-to-drive state. The method responds to the authentication of the operator by commanding disengagement of an Electronic Steering Columns Lock (ESCL) and commanding an electric power steering motor to exert torque to relieve load on the ESCL. Authentication of the operator may be based on, for example, insertion of a key in an ignition switch, a button press of a wireless key fob, or operation of a driver door. The method responds to the request to enter the ready-to-drive state by permitting generation of tractive force in response to depression of an accelerator pedal only if the ESCL is disengaged. The request to enter the ready-to-drive state may be based on rotation of a key in an ignition switch. The method may further include suspending operation of the electric power steering motor and commanding the ESCL to re-lock if no request to enter the ready-to-drive state is received within a predetermined time after the authentication of the operator. The method may also firther include responding to the operator request to enter the ready-to-drive state by starting an internal combustion engine.

A controller includes communication channels and control logic. The communications channels receive signals from a steering column torque sensor and a driver authentication system. The communication channels send signals to an an Electronic Steering Column Lock (ESCL) and a power steering motor. The control logic is configured to respond to an authentication signal by commanding the power steering motor to relieve a load on the ESCL as sensed by the steering column torque sensor and by commanding disengagement of the ESCL. The control logic may be further configured to respond to a request to enter a ready-to-drive state by testing a state of the ESCL and permitting generation of tractive force only if the ESCL is disengaged. The control logic may also be further configured to suspend operation of the power steering motor and to command the ESCL to re-lock if no request to enter the ready-to-drive state is received within a predetermined time after receiving the authentication signal.

### BRIEF DESCRIPTION OF THE DRAWINGS

FIG. 1 is a schematic diagram of a vehicle steering system.

FIG. 2 is a schematic cross section of the Electronic Steering Column Lock of FIG. 1 in an engaged position.

FIG. 3 is a schematic cross section of the Electronic Steering Column Lock of FIG. 1 in a disengaged position.

FIG. 4 is a flow chart of a first method of controlling the vehicle steering system of FIG. 1.

FIG. 5 is a flow chart of a second method of controlling the vehicle steering system of FIG. 1.

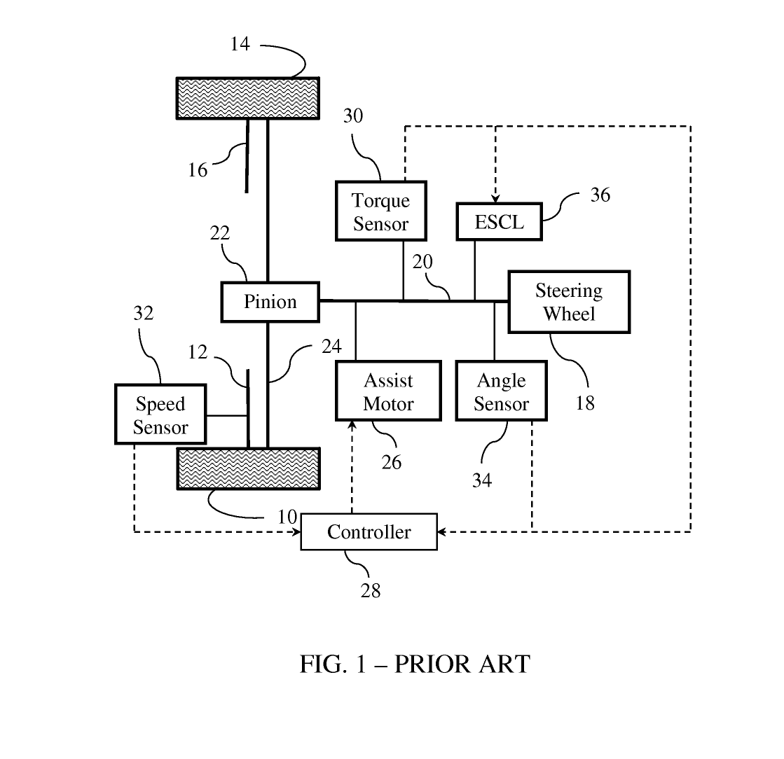

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

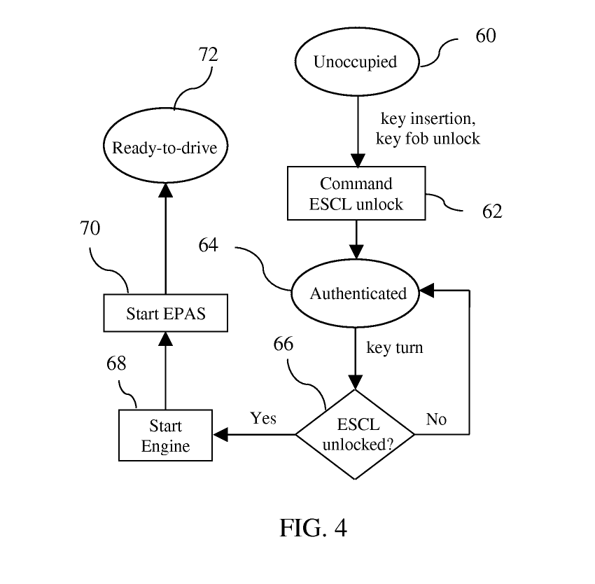

FIG. 4 illustrates one method of operating an Electronic Power-Assisted Steering (EPAS) system and an Electronic Steering Column Lock (ESCL). The method begins when the vehicle is an unoccupied state at 60. The vehicle transitions out of unoccupied state in response to a key insertion or key fob unlock event. A key fob unlock event may occur when the door unlock button on the key fob is pressed or when a person with a keyless entry key fob touches the door handle. Upon leaving the unoccupied state, controller 28 commands the ESCL to unlock at 62 before entering the authenticated state at 64. In the authenticated state, some vehicle functions may be activated, such as courtesy lights. However, the vehicle does not respond to depression of the accelerator pedal in the authenticated state. The vehicle transitions out of the authenticated state in response to a key turn event. For vehicles equipped with push-button start, pushing the start button generates a key turn event even though no physical key is used. In response to the key turn event, controller checks at 66 whether the ESCL successfully unlocked. If not, the vehicle returns to the authenticated state. If the ESCL is successfully unlocked, controller 28 commands an engine start at 68. For an electric vehicle or hybrid electric vehicle, this step may be omitted or performed later. Then, the EPAS system is activated at 70 before entering the ready-to-drive state at 72. In the ready-to-drive state, the vehicle responds to depression of the accelerator pedal according to the current position of the shift selector. If the shift selector is in the Drive or Low position, the vehicle responds by accelerating forward. If the shift selector is in the Reverse position, the vehicle responds by accelerating backward.

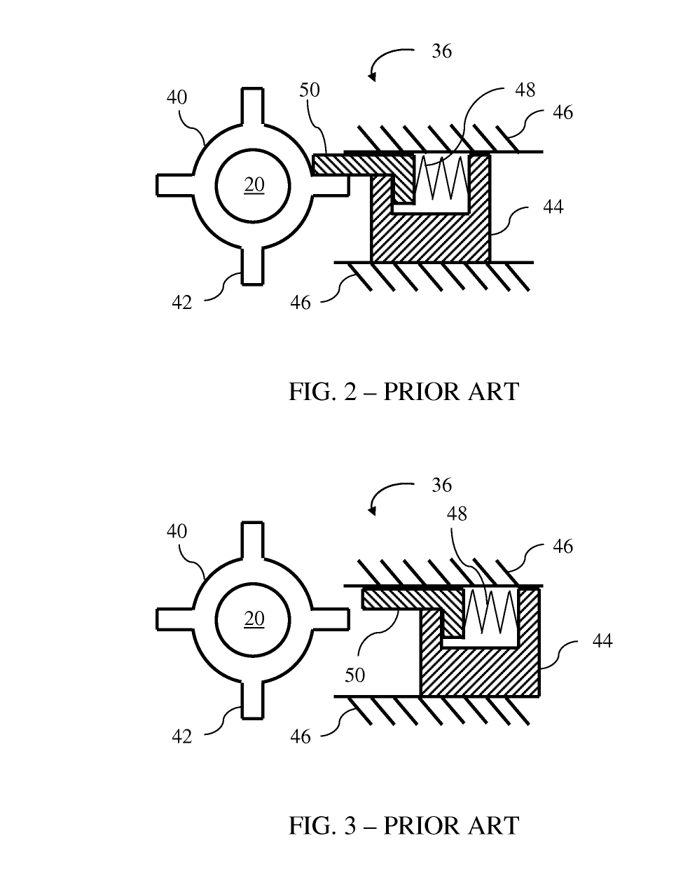

Checking for ESCL unlock at 66 is necessary because there are situations in which the ESCL does not release when commanded to unlock at 62. If steering column 20 is under torsion, then there may be a normal force between pin 50 and one of the teeth 42. The normal force may result in enough friction that the solenoid or motor is unable to translate the carriage 44 from the position of FIG. 2 to the position of FIG. 3. There are several reasons that steering column 20 could be under torsion while the vehicle is in the unoccupied state. In one scenario, when the ESCL was engaged, pin 50 may have been blocked by a tooth and not dropped in until the driver forcibly turned the steering wheel. When the driver released the steering wheel, the steering columns remains under torsion. In another scenario, a force may have started to act on one of the front wheels after the vehicle was parked. If the force acted to turn the wheel, it would have been resisted by the ESCL causing the steering column to be under torsion. One example scenario involving such a force occurs when the vehicle rolls into a curb. A driver typically becomes aware of the issue when the engine does not start in response to key turn event. In some cases, the driver may be able to force the steering wheel to turn far enough that the normal force is relieved and the ESCL unlatches. In other cases, the driver may not recognize that forcing the steering wheel would correct the problem or may not be strong enough to generate sufficient torque.

Some vehicles are equipped with remote starting systems. These systems allow the driver to start the engine from a distance in cold weather such that engine and passenger compartment are warm when the driver enters the vehicle. In response to a remote start event, the vehicle transitions from the unoccupied state, commands the ESCL to unlock, and then starts the engine only if it confirms that the ESCL did unlock. The vehicle does not enter the ready-to-drive state until further events indicate the presence of an authorized driver. If the ESCL stick in the locked condition following a remote start event, the driver typically will not recognize that there is an issue until they enter the car and discover that it is still cold.

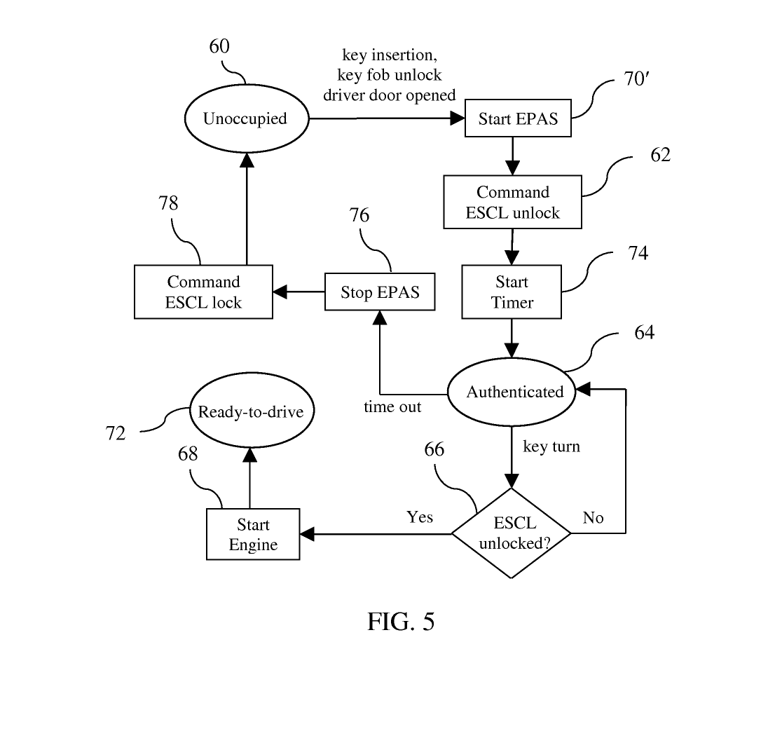

FIG. 5 illustrates another method of operating an Electronic Power-Assisted Steering (EPAS) system and an Electronic Steering Column Lock (ESCL). As with the method of FIG. 4, the vehicle transitions out of unoccupied state in response to a key insertion or key fob unlock event. The vehicle also transitions out of the unoccupied state in response to a driver door open event. Unlike the method of FIG. 4, the EPAS is started at 70′ before commanding the ESCL unlock at 62. If the steering column 20 is under torsion, torque sensor 30 will communicate that to controller 28. In response, controller 28 will, based on normal EPAS processing, command assist motor 26 to exert a torque to relive the torsion. In most cases, the torsion will be relived sufficiently for the ESCL to release when commanded. Even if the ESCL does not release, the amount of torque that the driver must exert in order to release the ESCL will be considerably reduced.

It may be undesirable to operate the EPAS system for too long without running the engine. Therefore, a timer is started at 74. If the timer expires while the vehicle is in the authenticated state at 64, the controller stops the EPAS systems at 76, commands the ESCL to lock at 78, and returns to the unoccupied state 60.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A vehicle comprising:
a steering column;
an Electronic Steering Column Lock (ESCL) engageable to limit rotation of the steering column;
an Electronic Power-Assisted Steering system (EPAS) including a sensor configured to detect a torque on the steering column and a motor configured to relieve the torque; and
a controller programmed to respond to authentication of an operator by activating the EPAS to relieve a load on the ESCL and commanding disengagement of the ESCL.

2. The vehicle of claim 1 wherein the controller is further programmed to respond to a request to enter a ready-to-drive state by testing a state of the ESCL and permitting generation of tractive force only if the ESCL is disengaged.

3. The vehicle of claim 2 wherein the controller is further programmed to suspend operation of the EPAS and command the ESCL to re-lock if no request to enter the ready-to-drive state is received within a predetermined time after the authentication of the operator.

4. The vehicle of claim 2 wherein authentication of the operator is based on insertion of a key in an ignition switch.

5. The vehicle of claim 4 wherein the request to enter the ready-to-drive state is based on rotation of the key in the ignition switch.

6. The vehicle of claim 2 wherein authentication of the operator is based on a button press of a wireless key fob.

7. The vehicle of claim 2 wherein authentication of the operator is based on operation of a driver door.

8. A method of controlling a vehicle comprising:
in response to authentication of an operator, commanding disengagement of an Electronic Steering Columns Lock (ESCL) and commanding an electric power steering motor to exert torque to relieve load on the ESCL; and
in response to an operator request to enter a ready-to-drive state, permitting generation of tractive force in response to depression of an accelerator pedal only if the ESCL is disengaged.

9. The method of claim 8 further comprising:
suspending operation of the electric power steering motor and commanding the ESCL to re-lock if no request to enter the ready-to-drive state is received within a predetermined time after the authentication of the operator.

10. The method of claim 8 further comprising:
in response to the operator request to enter the ready-to-drive state, starting an internal combustion engine.

11. The method of claim 8 wherein authentication of the operator comprises insertion of a key in an ignition switch.

12. The method of claim 11 wherein the request to enter the ready-to-drive state comprises rotating the key in the ignition switch.

13. The method of claim 8 wherein authentication of the operator comprises a button press of a wireless key fob.

14. The method of claim 8 wherein authentication of the operator comprises operating a driver door.

15. A controller comprising:
communications channels configured to receive signals from a steering column torque sensor and a driver authentication system and to send signals to an Electronic Steering Column Lock (ESCL) and a power steering motor; and
control logic configured to respond to an authentication signal by commanding the power steering motor to relieve a load on the ESCL as sensed by the steering column torque sensor and by commanding disengagement of the ESCL.

16. The controller of claim 15 wherein the control logic is further configured to respond to a request to enter a ready-to-drive state by testing a state of the ESCL and permitting generation of tractive force only if the ESCL is disengaged.

17. The controller of claim 16 wherein the control logic is further configured to suspend operation of the power steering motor and to command the ESCL to re-lock if no request to enter the ready-to-drive state is received within a predetermined time after receiving the authentication signal.
